(19) United States
(12) Patent Application Publication
(10) Pub. No.: US 2005/0027631 A1
(43) Pub. Date: Feb. 3, 2005

(54) System and method for providing information over a communications network

(75) Inventor: Kevin P. McAtee, Bozeman, MT (US)

Correspondence Address: SHOOK, HARDY & BACON LLP, 2555 GRAND BLVD, KANSAS CITY,, MO, 64108, US

(73) Assignee: Bandersnatch Research LLC

(21) Appl. No.: 10/632,718

(22) Filed: Aug. 1, 2003

(51) Int. Cl. G06F 17/60

(52) U.S. Cl. 705/36

(57) ABSTRACT

The present invention generally relates to a method and system for gathering, arranging and providing information, such as investment information, to computer users over a communications network such as the Internet. In one embodiment, the present invention includes the steps of gathering a number of information item about a particular company or industry, summarizing those information items, assigning a reliability indicator to certain information items, and storing the items in a database. When a subscriber requests information concerning a particular company, the pertinent information items are retrieved and presented to the subscriber as an electronic page that includes a graphical representation of the company's stock price and trading volume for a selected time period. Additionally, when the subscriber indicates a data point, a summary of certain information items, including the reliability indicator for each item, associated with the data point appear for the subscriber's review. In another embodiment, the present invention is a system that includes at least a data storage module, a chart engine, and a communications module. In this embodiment, information items are gathered, summarized, and stored in the data structure module with certain information items being assigned a reliability indicator. In response to a subscriber's request, the chart engine retrieves pertinent information items from the data storage module and creates an electronic page. Thereafter, the chart engine provides the electronic page to the communications module which makes it available to a subscriber.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to a system and method for gathering, arranging and providing information to computer users. More particularly, the present invention relates to a system and method for efficiently gathering, arranging and providing useful investment information over a communications network to computer users.

The reasonably prudent investor relies heavily on the ability to obtain timely, useful information. For example, before purchasing a company's stock, an investor will seek to learn pertinent information about the company and its industry and/or market, such as the company's share price and trading volume for a given time period and events that may have affected the share price. Similarly, after an investor has invested in a company, he or she will seek to monitor the company's performance and any events that may affect that performance.

Prior to the advent of the Internet, an investor had few options for how he or she could gather information in a timely fashion. The investor, for example, could personally monitor a stock exchange, news services and publications, corporate filings, and other sources in order to obtain information. However, many investors found that the volume of available information was overwhelming and confusing and required a significant, and often frustrating, commitment of time and resources. Thus, many investors elected to obtain information from an investment counselor or advisor, either in addition to or in the alternative to gathering information themselves. This option was not an optimal solution for many investors, however, because of the cost and the difficulty in finding a trustworthy, skilled, and knowledgeable advisor.

Concurrent with the growth in popularity of the Internet, a number of services have become available that purport to provide quality investment information in a professional manner and without great cost. Unfortunately, these services typically offer information only from a limited number of sources. In addition, in certain cases, the services are biased or influenced by the companies or the industries they are reporting about so that the information provided is not necessarily impartial or objective. Moreover, the services do not provide their information in an efficient manner or offer an effective method or means to quickly determine the reliability of the information provided. For these and other reasons, these services also are not optimal for many investors.

It is apparent, therefore, that a system and method for gathering, storing and providing useful information to investors in an effective, efficient manner is needed. More particularly, it is apparent that a system and method is needed for gathering, summarizing, assigning a reliability code, storing and making available over a communications network pertinent information to investors.

### SUMMARY OF THE INVENTION

The present invention generally relates to a method and system for gathering, arranging and providing information to computer users over a communications network. In one embodiment, the present invention is utilized to gather, store and make available investment information. In this embodiment, information items about a particular company, including the stock price and trading volume for a particular date (data items) and any article or other report published on a particular date (content items), are gathered from a number of sources, including stock exchanges, news services, magazines, trade publications, government filings and the like. The articles or other reports are assigned a reliability indicator and, with the other information items, are cross-referenced and stored in a data storage module, such as a database. When a remote subscriber requests information concerning a particular company, a chart engine utilizes the pertinent information items stored in the data storage module to create an electronic page containing a graphical representation for a portion of the information items arranged by date. The electronic page is then made available to the subscriber over a communications network.

The graphical representation contained on the electronic page generally includes a number of graphs or charts. In the investor information embodiment, the electronic page includes at least a graph showing stock price and trading volume for a selected time period. When the subscriber selects a particular data point within the graphical representation, the information items associated with or linked to the data point are displayed along with any assigned reliability indicators. In one embodiment, reliability is indicated by color-coding. Thus, the title or summary of an information item having a high level of reliability may appear in green while the title or summary of an information item having a low level of reliability may appear in yellow. The reliability factor enables the subscriber to quickly determine if he or she should review the information item further. If the subscriber chooses an item to review further, a more complete summary of the item is provided. If the subscriber elects to review the item even further, he or she is directed to the source of the information item.

In another embodiment, the present invention is a system that includes at least a data storage module, a chart engine and a communications module. In this embodiment, information items that have been gathered are stored in the data storage module along with any assigned reliability codes. In response to a remote user's selection, which is received by the communications module and passed by that module to the chart engine, the chart engine retrieves pertinent information items from the data storage module and creates an electronic page containing a graphical representation of a portion of the information items arranged by date. Thereafter, the chart engine provides the electronic page to the communications module, and the communications module makes the electronic page available to the user.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary communications network environment suitable for use in implementing the present invention;

FIG. 2 is a block diagram illustrating a method for implementing one embodiment of the present invention;

FIG. 3 is a block diagram illustrating part of a web site that may be utilized in one embodiment of the present invention;

FIG. 4 is a block diagram illustrating an exemplary electronic page that may be provided to a user according to one embodiment of the present invention;

FIG. 5 is a block diagram illustrating additional information that may be provided to a user according to one embodiment of the present invention;

FIG. 6 is a block diagram illustrating additional information that may be provided to a user according to one embodiment of the present invention;

FIG. 7 is a block diagram illustrating additional information that may be provided to a user according to one embodiment of the present invention;

FIG. 8 is a block diagram illustrating a system implementing one embodiment of the present invention; and

FIG. 9 is a block diagram illustrating part of a web site that may be utilized in one embodiment of the present invention.

### DETAILED DESCRIPTION OF THE INVENTION

The present invention provides a method and system for gathering, storing and providing information to a computer user over a communications network. In a preferred embodiment, the system and method provide investment information to subscribers. Initially, the system and/or method provide the subscriber with an electronic page having pertinent graphs and/or charts containing or representing pertinent information items. Certain information items are presented with a reliability indicator so that the subscriber may quickly and efficiently determine the value of the information item. Additionally, the system and method allow the subscriber to select an information item for further review and allow the subscriber to review the source of the information item.

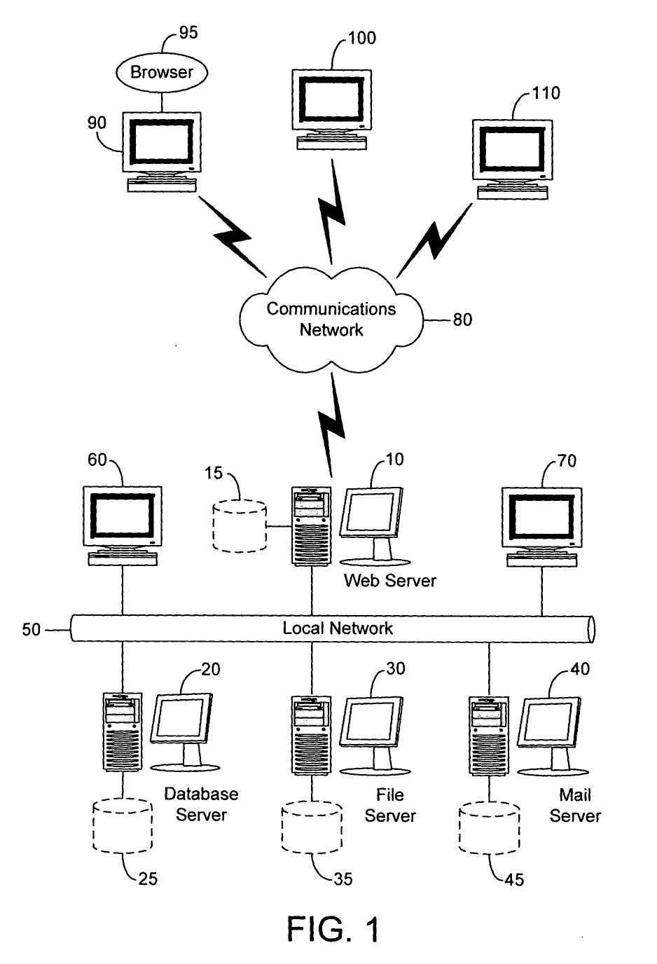

FIG. 1 illustrates an exemplary computer network environment on which the invention may be implemented. It should be understood that the computer network environment shown is only one example of a suitable network environment and is not intended to suggest any limitation as to the scope of the invention. As those skilled in the art will appreciate, the invention may be practiced with other network configurations.

As shown in FIG. 1, a Web server 10 is interconnected to a number of other server computers, such as a database server 20, a file server 30 and a mail server 40. Web server 10 includes a storage device 15. Similarly, database server 20, file server 30 and mail server 40 include storage devices 25, 35 and 45 respectively. In this example, Web server 10, database server 20, file server 30 and mail server 40 are part of a local area network 50. Also connected to network 50 are workstations 60 and 70.

A wide area communications network 80 (e.g. the Internet) permits remote subscriber computers 90, 100 and 110 to gain access to Web server 10, for example to request information concerning a particular company. Generally, a subscriber computer, such as computer 90, includes a browser function or separate browser application 95 that may locate and display electronic pages to a user. When a user at subscriber computer 90 desires to see an electronic page, browser 95 may cause subscriber computer 90 to issue a request that includes the URL (Uniform Resource Locator) value for the page sought in an HTTP (HyperText Transfer Protocol)-coded command. A URL value is a unique address that specifies the location of a content object on the Internet. HTTP is the standard World Wide Web client-server protocol used for the exchange of information between a Web browser and a Web server. Most commonly, the information is an electronic page in the form of an HTML (HyperText Markup Language) document. HTML is a standard coding convention and set of codes for attaching presentation and linking attributes to informational content within electronic pages. HTTP also includes several different types of messages that can be sent from a client to a server to request different types of server actions.

After receiving a request for a HTML document, Web server 10 will either obtain the HTML document, for example from file server 30, or assemble the HTML document from an HTML file. During a document's authoring stage, HTML codes are embedded within the informational content of the document. When the document is subsequently transmitted by a Web server to a Web browser, the codes are interpreted by the browser and used to parse and display the document. Thus, an HTML document is a special type of electronic page which includes HTML codes to permit the document to be viewed using a Web browser program. An HTML document that is accessible on a World Wide Web site is commonly referred to as a “Web document” or “Web page.”

If the HTML document is assembled, Web server 10 will process the instructions and information stored in the HTML file, extract any queries from the file and issue those queries, for example to database server 20. Database server 20, in turn, may issue queries to file server 30 or some other computer. Web server 10 will receive the results of these queries, merge that information with the contents of the HTML file and execute any instructions to generate an HTML document. The HTML document is then routed via communications network 80 to subscriber computer 90 where browser 95 operates to display the page. The operation of Web browsers, the Internet, the World Wide Web and HTML authoring systems are well-known in the art.

As stated above, the present invention may be embodied as a method or a system implemented in a computing environment. Thus, when implemented, the present invention may be composed of computer-executable instructions, such as HTML instructions, that may be grouped together in program modules. Generally, a program module will include programs, objects, components, data structures, etc. that perform particular tasks or implement particular abstract data types. In a distributed computing environment or a computer network environment, program modules may be located in one or more local or remote computer storage media including memory storage devices.

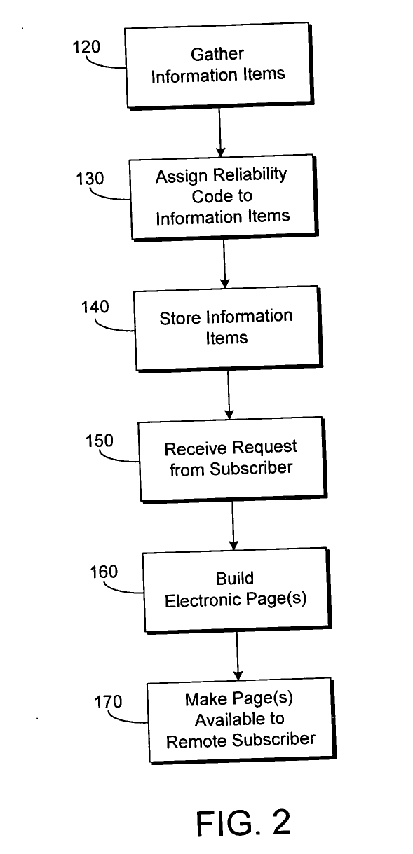

As previously mentioned, in one embodiment the present invention is embodied as a method, such as is illustrated in FIG. 2. The method begins at step 120 where at least one information item is gathered. Generally, information items are gathered from a number of sources. For example, an information item may be gathered from articles provided by news services including local, national and international services, such as newspapers and wire services. In addition, an information item may be gathered from other publications, such as trade journals or magazines, and from government filings. As stated, in one embodiment, the present invention provides information to investors. In this embodiment, information items may be gathered from newspapers such as the Wall Street Journal, from magazines such as Money magazine or Forbes magazine, from the Securities and Exchange Commission, and from a stock exchange. Moreover, information items may be gathered from publications provided by the companies, such as shareholder reports, and from industry associations.

To gather an information item, first pertinent information is found. In one embodiment, pertinent information includes any article discussing or describing any corporate activity, including officer activity, or an event and may be found through the use of a search engine employing key words such as the company's name. Next, details concerning the information item are recorded. These details may include the date and source for the item, and the author of the item, a brief summary of the item's content, and a more detailed summary of the item's content if applicable. Additional details, such as cited references, may also be included.

At step 130, certain information items are assigned a reliability indicator that is indicative of the weight or value of the information. For example, in the embodiment providing investment information, an information item derived from a Securities and Exchange Commission document or filing or from a state corporation commission document or filing are assigned an indicator indicative of the highest possible reliability level, as is an information item derived from a company publication. An information item obtained from a widely accepted source, such as the Wall Street Journal or Forbes magazine and the like, typically is assigned an indicator indicative of a second level of reliability, while an information item obtained from a trade journal, an editorial column, and the like generally is assigned an indicator indicative of a third level of reliability. An information item that includes only a stock price or trading volume will not be assigned a reliability indicator.

After assigning a reliability indicator, at step 140, the information item and its reliability indicator, if applicable, are stored together in a searchable data storage module, such as a database. Many commercially-available databases, such as Microsoft Access or Microsoft SQL, which are available from the Microsoft Corporation of Redmond, Wash., may be utilized to store information items. Additionally, a custom designed data storage module may also be utilized and is within the scope of this invention. It should also be understood that additional entries may also be associated with an information item in the data structure or database, such as a link to or URL address for an electronic copy of the source of the information item.

Next, at step 150, a request is received from a user that indicates that the user desires to view certain information items. In the investor information embodiment, for example, a subscriber may indicate that he or she is interested in seeing information concerning a particular company. The subscriber may provide his or her indication by utilizing a pointing device (e.g. a mouse) to select a particular company from a pull down menu or by typing a company name in an input space.

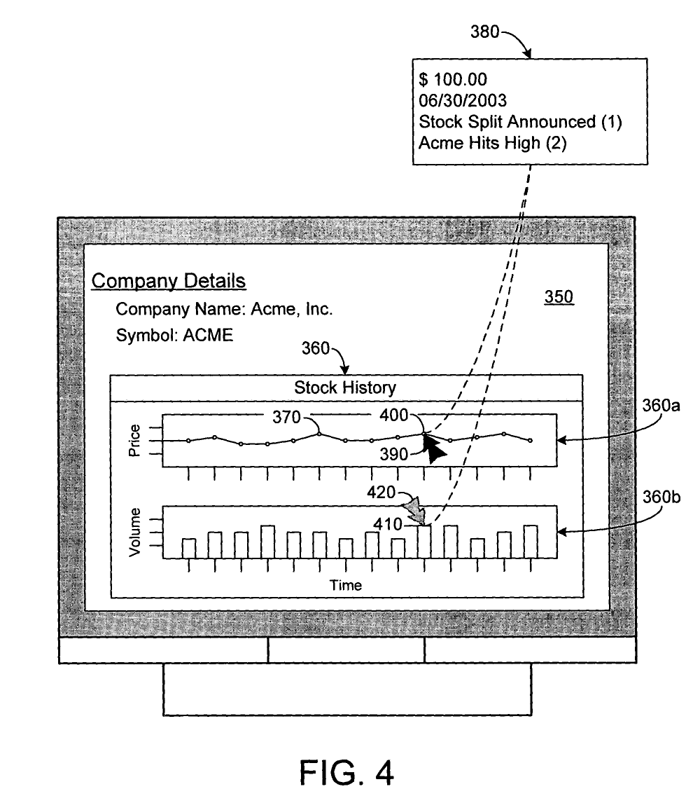

At step 160, after receiving a request, an electronic page is built. According to one embodiment of the present invention, the electronic page appears as shown in FIG. 4, which will be discussed in more detail below.

At step 170 the electronic page is made available to the subscriber. This may be accomplished, for example, by sending the electronic page over communications network 80 in FIG. 1 from Web server 10 to subscriber computer 90. Once received at subscriber computer 90, browser 95 operates to display the electronic page on the display associated with computer 90. An additional example for completing step 170 includes providing a URL address for the electronic page to a subscriber's browser so that the browser may send a request to the computer containing the electronic page.

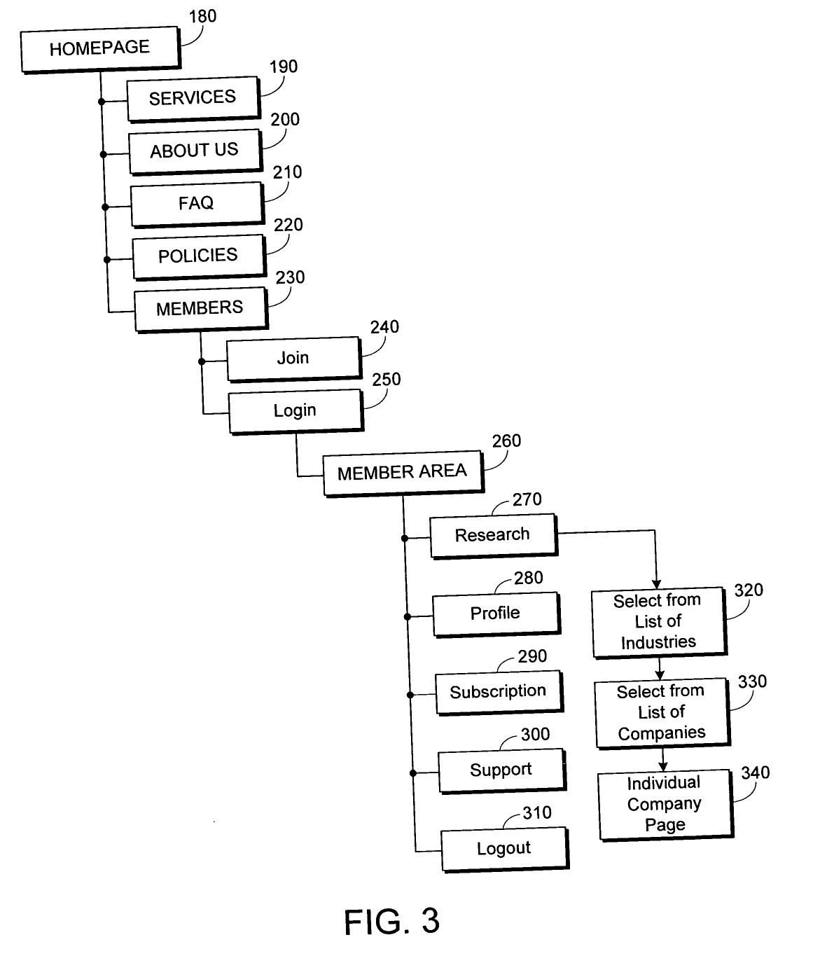

Referring now to FIG. 3, in one embodiment of the present invention, the electronic page is made available to users from a Web site. Initially, a computer user accesses (in a manner that is well-known) a Homepage 180 that contains general information. From Homepage 180, the computer user can access electronic pages for either Services 190, About Us 200, FAQ 210, Policies 220 or Members 230 by selecting the appropriately titled button. If the computer user elects to access the electronic pages for either Services 190, About Us 200, FAQ 210, or Policies 220, he or she will receive an electronic page containing background and/or other miscellaneous information. These electronic pages may contain, for example, statements addressing the complete independence of the service provider so that the computer user is assured that the information items contained therein are unbiased and statements concerning research methods so that the computer user is assured that the information items provided are complete.

If the computer user elects to access Members electronic page 230, he or she is will receive an electronic page from which the computer user may access the Join electronic page 240 or the Login electronic page 250. The Join electronic page 240 allows the computer user to enter information, including method of payment information (e.g., credit card, debit card, automatic withdrawal, etc.), required to become a subscriber. (It should be understood that the Web site will utilize known software programs and/or techniques to obtain credit card/account verification and to obtain payments.) Login electronic page 250 allows computer users who are already subscribers to enter their password and thereby receive Members Area electronic page 260.

Members Area electronic page 260 provides a subscriber with access to electronic pages for Research 270, Profile 280, Subscription 290, Support 300 and Logout 310. Profile electronic page 280 provides information concerning the subscriber's membership information. Subscription electronic page 290 provides information concerning the subscriber's subscription, and includes means to change the subscriber's subscription (e.g., from monthly to yearly). Support electronic page 300 provides access to assistance from the Web site operators if the subscriber is having difficulty with the Web site. Logout electronic page 310 allows the subscriber to terminate his or her session.

From Research electronic page 270, the subscriber is presented with a list of the industries currently available for review and asked to select an industry 320. Once that selection is made, the subscriber may select either a company from a list of the available companies within the selected industry or an industry details button 330. If the subscriber selects a company, he or she is presented with an electronic page for the individual company 340a. If the subscriber selects the industry details button, he or she is presented with an industry details electronic page 340b. It should be understood that in an alternate embodiment, after receiving an electronic page for a particular company 340a, the subscriber may select another company 330 within the industry without returning to industry selection choice 320.

Turning now to FIG. 4, the electronic page 350 the subscriber receives upon selection of a company contains a graphical representation 360 that includes share price chart 360a and trading volume chart 360b for a particular time period (i.e. a timeline) for the company selected by the subscriber. Share price chart 360a contains a number of data points 370 representing the average share price for a division of the particular time period (a date range), such as a week or a day. Trading volume chart 360b contains similar data points. It should be understood that the particular time period may be selected by the subscriber. In this manner, a subscriber may easily obtain and review the historical stock data as a function of time for a subject company.

Continuing with FIG. 4, in a preferred embodiment, after receiving electronic page 350 if the subscriber moves his or her pointing device over a data point 370 a pop-up box, such as box 380, appears that contains relevant information items retrieved from the data storage module that are tied to the data point. For example, pop-up box 380, which is generated when a subscriber rolls his or her pointer 390 over data point 400, contains a share price for Acme, Inc.'s stock of $100.00 on Jul. 30, 2003. Additionally, pop-up box 380 contains the summaries from two additional information items and the reliability indicators assigned to those information items. It should be understood that a pop-up box similar to pop-up box 380 (e.g. it may have trading volume data instead of a share price data) may also appear when a subscriber rolls his or her pointer over data point 410 (as indicated by shadow pointer 420). Finally, it should be understood that in this embodiment a data point corresponds with a date or date range and, thus, a subscriber can review historical information items. This feature is useful, for example, if a subscriber notes a significant change in share price and elects to investigate the events that may have caused the change.

As indicated above, certain information items are stored with a reliability indicator. Reliability indicators or codes include, but are not limited to, colors, symbols, typeface, numbers, letters and the like, and including combinations of the same. For example, a brief summary of an information item having the highest level of reliability assigned may be shown in green or with the number 1 in parenthesis, as in pop-up box 380 in FIG. 4, while a brief summary of an information item having the next level of reliability assigned may be shown in blue or with the number 2 in parenthesis, again as in pop-up box 380 in FIG. 4. Reliability indicators may be assigned manually or automatically based on the source of the information item, as described above, or the author of the information item, or some other applicable factor.

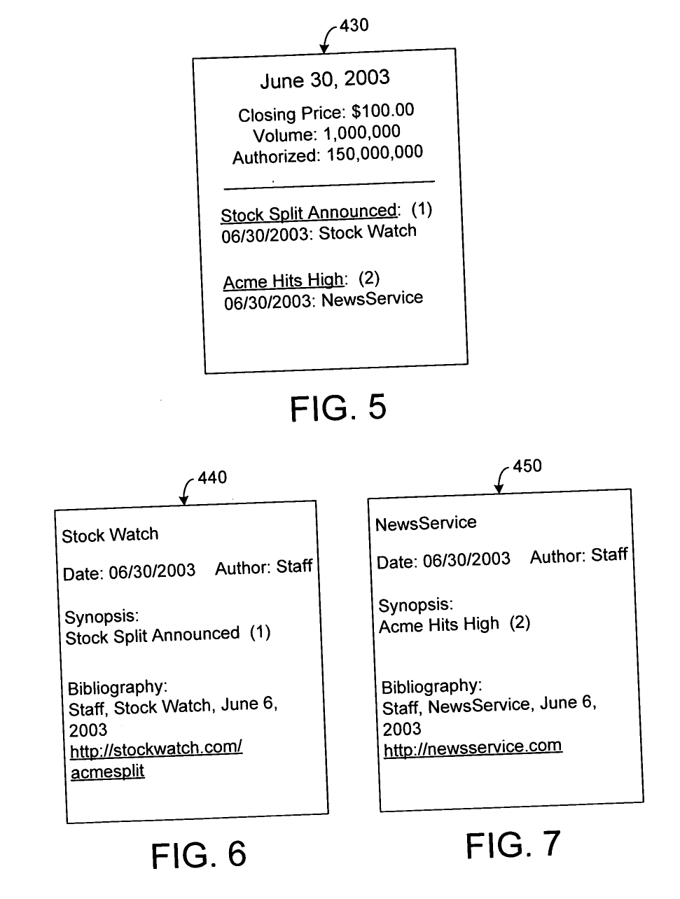

In addition to viewing the contents of pop-up box 380, a subscriber may also select box 380, such as by clicking his or her mouse inside box 380, which causes box 430 (shown in FIG. 5) to appear. Box 430 contains the information items found in box 380 concerning the selected company as well as additional information items, such as the number of authorized shares. Box 430 also contains links to further details for each information item. For example, if the subscriber selects “Stock Split Announced” in box 430, then box 440 (FIG. 6) appears. In addition to the information item details already displayed, box 440 contains the author's name and bibliographical data for the source of the information item (in this case an article), including a link to a copy of the source should the subscriber decide to read the source personally. The subscriber will receive box 450 (FIG. 7) if he or she selects “Acme Hits High” in box 430. The process of making a selection in one box so as to receive additional details from an information item may be referred to as “drilling down” into the information item.

As indicated above, if the subscriber selects the industry details button at box 330 in FIG. 3, he or she will be presented with an industry details electronic page 340b. In one embodiment, this electronic page is functionally similar to electronic page 350, that is the page will include a graphical representation having a number of data points and if the subscriber moves his or her pointing device over the data points a pop-up box will appear containing relevant information items retrieved from the data storage module that are tied to the data point.

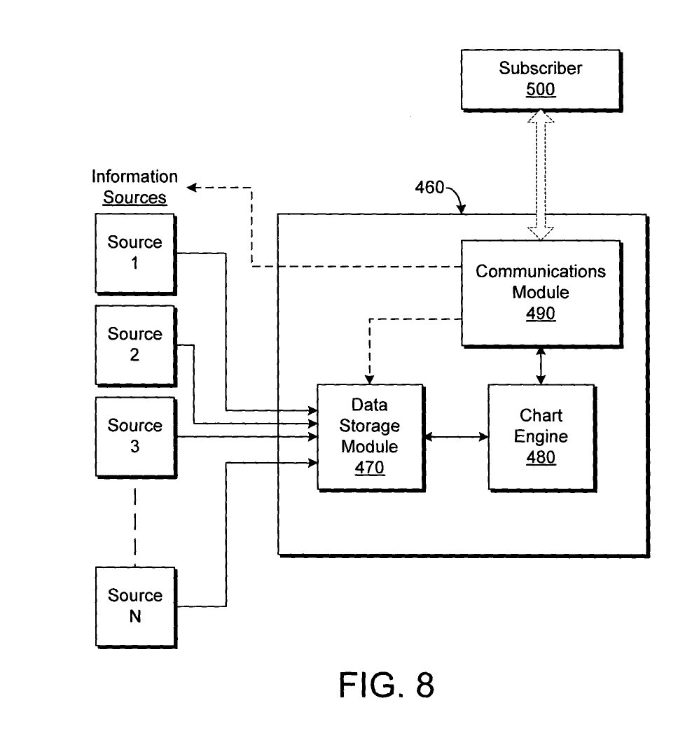

Referring now to FIG. 8, one embodiment of a system for providing information to a client over a computer network is generally denominated by the numeral 460 and contains a data storage module 470, a chart engine module 480 and a communications module 490. It should be understood that system 460 may be fully contained or stored within a single computer, such as Web server 10 or workstation 60. In the alternative, the individual modules that make up system 460 may be contained or stored on different, separate computers, such as Web server 10 and database server 20.

As stated, system 460 includes data storage module 470. As indicated above, data storage module 470 stores details for the information items and, when applicable, an item's associated reliability code. Additionally, module 470 is searchable, able to respond to requests for specific data, and able to communicate with other modules and computers. As further mentioned above, module 470 may be a commercially-available database program such as Microsoft Access or Microsoft SQL available from Microsoft Corporation in Redmond, Wash. Other commercially-available database programs may also be utilized. Also, a custom-designed data storage module may be employed. Such a module might be embodied as a computer having at least a storage device, such as a hard drive, and containing and executing software instructions specifically written for system 460. Data storage module 470 may be implemented, for example, on database server 20, on Web server 10 or on workstations 60 or 70 in FIG. 1.

System 460 also includes chart engine module 480. One commercial program that may be utilized as chart engine module 480 is the PopChar5™ program offered by Corda Technologies, Inc. of Lindon, Utah. (Information about PopChart5™ printed from Corda Technologies' Web site on Jul. 16, 2003 may be found below at pages A1-A17; this information is included as part of this specification and is incorporated herein by reference). Chart engine module 480 should be capable of receiving a request for information (for example from communications module 490), obtaining the required information or information items from a data storage module, building an electronic page containing the requested information items or representing the requested information items and providing the electronic page to the requesting module or computer. Module 480 may be employed in a networked system as shown in FIG. 1 or on an individual computer. Module 480 may be stored on a different computer from data storage module 470. For example, chart engine module 480 may be stored and executed on Web server 10 while data storage module 470 may be stored and executed on database server 20.

System 460 further includes communications module 490. Communications module 490 is responsible for interacting with subscribers over a communications network such as the Internet. This interaction may include sending electronic pages to and receiving selections, requests and other data from subscribers. Module 490 is also operable to communicate a subscriber's request for information (including drill down requests) to chart engine module 480 and to provide the electronic page or pages (or addresses) generated by chart engine module 480 to subscribers. Additionally, module 490 is operable to communicate with module 470 or with other computer systems, Web sites and the like to obtain source documents or articles when requested by a subscriber.

In operation, a researcher or other person must gather, assign reliability indicators and store information items in data storage module 470. For an investment information system, information items may include the closing share price and trading volume for a specific day or week (data items) or articles reporting corporate activity or other events, such as a product launch or a lawsuit (content items). “Articles” may also include corporate filings that describe, for example, a stock issue or split or a merger, acquisition or asset sale.

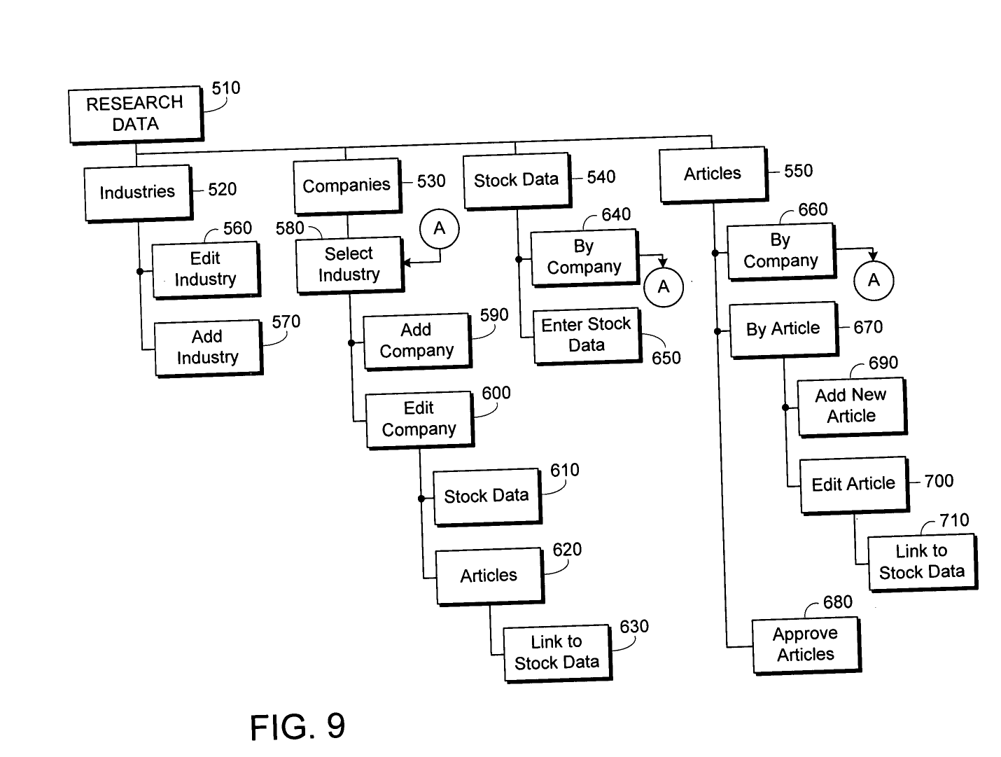

In one embodiment, the researcher will access a Web site, such as the site represented in FIG. 9, to accomplish these tasks. Initially, the researcher will access Research Data electronic page 510. From page 510, the researcher may access Industries electronic page 520, Companies electronic page 530, Stock Data electronic page 540 or Articles electronic page 550.

If the researcher accesses Industries electronic page 520, he or she will be presented with the choice of either accessing Select Industry electronic page 560 or Add Industry electronic page 570. From Select Industry electronic page 560, the researcher will select a particular industry and then elect to access either Industry Data electronic page 580 or Articles electronic page 590. From Industry Data electronic page 580, the researcher may add, review and edit industry data, such as the industry rating for a particular day or the details concerning the industry (e.g. the companies included in the industry), for the selected industry. From Articles electronic page 590, the researcher may add, review and edit the content items stored for the selected industry. In addition, Articles electronic page 590 allows the researcher to link a content item to a specific day's industry data 600. From Add Industry electronic page 570 the researcher may add an industry.

If the researcher accesses Companies electronic page 530, he or she will receive Select Industry electronic page 610 where he or she can select an industry. After selecting an industry, the researcher can access either Add Company electronic page 620 or Select Company electronic page 630. From Add Company electronic page 620 the researcher may add a company to the selected industry. From Select Company electronic page 630, the researcher will select a particular company and then elect either to access Stock Data electronic page 640 or Articles electronic page 650. From Stock Data electronic page 640, the researcher may add, review and edit data concerning the selected company's stock, such as the closing price and trading volume a particular day or week. From Articles electronic page 650, the researcher may add, review and edit the content items stored for the selected company. In addition, Articles electronic page 650 allows the researcher to link a content item to a specific day's stock data 660. It should be understood that frequently used links or URLs may be stored and provided to the researcher, for example in a separate electronic page, so that the researcher does not have to re-enter these links repeatedly.

After accessing Stock Data electronic page 540, the researcher may choose a particular company by utilizing the By Company option 670 or choose to access Enter Stock Data electronic page 680. If the researcher chooses By Company option 670, he or she will receive Select Industry electronic page 610 and proceed as described above. From Enter Stock Data electronic page 680, the researcher may enter company symbols, closing prices, shares traded and shares authorized for the tracked companies.

After accessing Articles electronic page 550, the researcher may choose the By Company option 690, choose to access By Article electronic page 700 or choose to access Approve Articles electronic page 710. If the researcher chooses By Company option 690, he or she will receive Select Industry electronic page 610 and proceed as described above. From By Article electronic page 700, the researcher may access Add New Article electronic page 720 or Edit Article electronic page 730. From Add New Article electronic page 720, the researcher may add new content items to data storage module 470. From Edit Article electronic page 730, the researcher may review and/or edit a content item already stored in data storage module 470 and to link the information item to a specific day's stock data 740. As with box 660 above, it should be understood that frequently used links or URLs may be stored and provided to the researcher, for example in a separate electronic page, so that the researcher does not have to re-enter these links repeatedly. Finally, Approve Articles electronic page 710 allows a research supervisor or editor to review, edit and approve proposed information items before those items are stored in data storage module 470.

It should be understood that with regard to FIG. 9, the use of the phrase “Stock Data” is not intended to imply that researchers are limited to using the web site for information items concerning corporations only. Instead, researchers may utilize the web site for information concerning any publicly-traded company It, including partnerships and the like.

Returning to FIG. 8, as stated, once he or she finds pertinent information, the researcher will create an information item and enter it into data storage module 470 as indicated by the arrows in FIG. 8 between sources 1 to n and data storage module 470. Included in the information item is a link to the source document or, possibly, an electronic version of the source document or a file name where an electronic version of the source document may be found.

Thereafter, communications module 490 will receive a request for information from a subscriber computer 500. Module 490 will communicate the request to chart engine module 480.

After receiving a request from communication module 490, chart engine module 480 will obtain the pertinent information items from data storage module 470 and generate the charts, graphs and/or other visual aids, including text, required to build an electronic page for the subscriber. It should be understood that the electronic page may include the information items, a link to the specific information items or a representation of the information items. After building the electronic page, module 480 communicates to module 490 that the page is prepared. Thereafter, module 490 may transmit the contents of the electronic page or the address of the electronic page to subscriber computer 500.

After reviewing the electronic page, a subscriber may drill down into an information item as described above. Thus, subscriber computer 500 may communicate a drill down request to communications module 490. Upon receiving such a request, which may be in the form of a URL, a file name or the like, module 490 may obtain the requested data from data storage module 470 or the source document from its source as indicated by the dashed arrows in FIG. 8.

Although the investment information embodiment has been discussed extensively above, it should be understood that the present invention is not limited to this embodiment. For example, the present invention may be used to present political polling information to the public. In that embodiment, instead of stock prices and trading volumes, the charts presented in electronic page 350 may reflect, for example, approval ratings. Similarly, the present invention may be used to present weather-related information, with the charts presented in electronic page 350 reflecting temperature and rainfall levels. As a yet another example, the present invention may be used to present marketing information, with the charts presented in electronic page 350 reflecting sales volumes and prices for different products.

From the foregoing it will be seen that this invention is one well adapted to attain all the ends and objects set for above, together with other advantages, which are obvious and inherent to the system and method. It will be understood that certain features and sub-combinations are of utility and may be employed without reference to other features and sub-combinations. This is contemplated and within the scope of the appended claims. Moreover, while particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

1. A method for providing information over a communications network to a computer user, said method comprising:
gathering a plurality of information items relating to a subject, said information items including data items and content items, wherein each of said data items includes the value of an attribute associated with said subject for a particular date and each of said content items includes a statement summarizing an occurrence for a particular date;
storing said information items; and
creating an electronic page containing in part a graphic representation that includes a number of data points corresponding to at least a portion of said data items, said data points arranged by date or date range.

2. The method of claim 1 further including assigning a reliability factor to each of said content items.

3. The method of claim 2 wherein said reliability indicators are different colors.

4. The method of claim 2 wherein said reliability indicators are different numbers.

5. The method of claim 2 wherein said reliability indicators are different typeface.

6. The method of claim 2 wherein said reliability indicators are different letters.

7. The method of claim 2 wherein said information items and said reliability indicators are stored in a data storage module.

8. The method of claim 2 wherein said information items and said reliability indicators are stored in a database.

9. The method of claim 2 further including
receiving a selection of a data point; and
providing a display containing the content items associated with the corresponding date or date range of the data point and the reliability indicators assigned to said content items.

10. The method of claim 2 wherein said information items are gathered from a plurality of sources.

11. The method of claim 10 wherein said sources include newspapers, wire services, magazines, trade journals, publicly available government documents, web casts, and web sites.

12. The method of claim 10 wherein said reliability indicators are determined by the source of the content item.

13. The method of claim 10 wherein said reliability indicators are automatically assigned depending upon the source of said content item.

14. The method of claim 1 wherein said subject is a company.

15. The method of claim 14 wherein said attributes include the share price for said company.

16. The method of claim 14 wherein said attributes include the share trading volume for said company.

17. The method of claim 1 wherein said occurrences include the publication of an article concerning said subject.

18. The method of claim 1 wherein said occurrences include publication of a document concerning said subject.

19. The method of claim 1 wherein said content items further include a reference to the source of said content item.

20. The method of claim 1 further including reviewing said content items for accuracy.

21. The method of claim 1 wherein said graphic representation is a bar chart.

22. The method of claim 1 wherein said graphic representation is a graph.

23. The method of claim 1 further including receiving a request from said computer user for information items concerning said subject.

24. The method of claim 23 wherein said request includes a date range.

25. The method of claim 1 further including transmitting said electronic page to said computer user.

26. The method of claim 25 wherein said electronic page contains all of the content items and reliability indicators that may be displayed when a data point is selected.

27. The method of claim 25 wherein said electronic page does not include content items and wherein said selection of a data point causes the content items associated with the date of said data point and the reliability indicators assigned to said content items to be transmitted to said computer user for display.

28. The method of claim 1 wherein said communications network is the Internet.

29. A computer readable medium having computer-executable instructions for performing the method recited in claim 1.

30. A system in a computer environment for providing information over a communications network to a computer user, said system comprising:
a data storage module operable to store information items relating to a subject, said information items including data items and content items, wherein each of said data items includes the value of an attribute associated with said subject for a particular date and each of said content items includes a statement summarizing an occurrence for a particular date;
a chart engine operable to create an electronic page containing in part a graphic representation that includes a number of data points corresponding to at least a portion of said data items, said data points arranged by date or date range; and
a communications module operable to receive communication from a computer user and to transmit said electronic page to said computer user.

31. The system of claim 30 wherein said data storage module is further operable to store a reliability factor assigned to each of said content items.

32. The system of claim 31 wherein upon selection of a data point said chart engine is further operable to cause the display of the content items associated with the corresponding date or date range of the data point and the reliability indicators assigned to said content items.

33. The system of claim 30 wherein said data storage module is a database.

34. The system of claim 30 wherein said communication received from said computer user includes a request for information items concerning said subject.

35. The system of claim 34 wherein said communication includes a date range.

36. The system of claim 30 wherein said subject is a company.

37. The system of claim 36 wherein said attributes include the share price for said company.

38. The system of claim 36 wherein said attributes include the share trading volume for said company.

39. The system of claim 30 wherein said graphic representation is a bar chart.

40. The system of claim 30 wherein said graphic representation is a graph.

41. The system of claim 30 wherein said communications network is the Internet.

42. A method for providing information over a communications network to a computer user, said method comprising:
receiving a plurality of information items relating to a subject, said information items including data items and content items, wherein each of said data items includes the value of an attribute associated with said subject for a particular date and each of said content items includes a statement summarizing an occurrence for a particular date;
storing said information items; and
creating an electronic page containing in part a graphic representation that includes a number of data points corresponding to at least a portion of said data items, said data points arranged by date or date range.

43. The method of claim 42 further including receiving reliability factor for each of said content items.

44. The method of claim 43 wherein said reliability indicators are different colors.

45. The method of claim 43 wherein said reliability indicators are different numbers.

46. The method of claim 43 wherein said reliability indicators are different typeface.

47. The method of claim 43 wherein said reliability indicators are different letters.

48. The method of claim 43 wherein said information items and said reliability indicators are stored in a data storage module.

49. The method of claim 43 wherein said information items and said reliability indicators are stored in a database.

50. The method of claim 43 further including
receiving a selection of a data point; and
providing a display of the content items associated with the corresponding date or date range of the data point and the reliability indicators assigned to said content items.

51. The method of claim 42 wherein said subject is a company.

52. The method of claim 51 wherein said attributes include the share price for said company.

53. The method of claim 51 wherein said attributes include the share trading volume for said company.

54. The method of claim 42 wherein said occurrences include the publication of an article concerning said subject.

55. The method of claim 42 wherein said occurrences include publication of a document concerning said subject.

56. The method of claim 42 wherein said content items further include a reference to the source of said content item.

57. The method of claim 42 wherein said graphic representation is a bar chart.

58. The method of claim 42 wherein said graphic representation is a graph.

59. The method of claim 42 further including receiving a request from said computer user for information items concerning said subject.

60. The method of claim 59 wherein said request includes a date range.

61. The method of claim 42 further including transmitting said electronic page to said computer user.

62. The method of claim 61 wherein said electronic page contains all of the content items and reliability indicators that may be displayed when a data point is selected.

63. The method of claim 61 wherein said electronic page does not include content items and wherein said selection of a data point causes the content items associated with the date of said data point and the reliability indicators assigned to said content items to be transmitted to said computer user for display.

64. The method of claim 42 wherein said communications network is the Internet.

65. A computer readable medium having computer-executable instructions for performing the method recited in claim 42.

66. A method of providing information to a computer user, said information including data items and content items, said data items including a value associated with a particular date, said content items including text associated with a particular date, said method comprising:
creating a first electronic page containing a graphic representation that includes a number of data points with each of said data points corresponding to a specific date or date range and corresponding to said data items associated with said date or said date range;
providing said first electronic page to said computer user;
receiving a selection of a data point;
creating a second electronic page containing said content items associated with the date or date range of the data point; and
providing said second electronic page to said computer user.

67. The method of claim 66 further including obtaining said data items and said content items from a database.

68. The method of claim 66 wherein said step of providing said first electronic page to said computer user includes transmitting said first electronic page over a communications network to said computer user.

69. The method of claim 68 wherein said communications network is the Internet.

70. The method of claim 68 wherein said step of providing said second electronic page to said computer user includes transmitting said second electronic page over a communications network to said computer user.

71. The method of claim 70 wherein said communications network is the Internet.

72. The method of claim 66 wherein said value is the stock price for a company.

73. The method of claim 66 wherein said value is the share trading volume for a company.

74. The method of claim 66 wherein said graphic representation is a bar chart.

75. The method of claim 66 wherein said graphic representation is a graph.

76. The method of claim 66 further including receiving a request for said first electronic page from said computer user.

77. The method of claim 66 wherein said first electronic page is a Web page.

78. A computer readable medium having computer-executable instructions for performing the method recited in claim 66.

79. A method for providing investment information over a communications network to a computer user, said method comprising:
gathering a plurality of information items relating to a company, said information items including data items and content items, wherein said data items include the share price and the trading volume for said company for a particular date and each of said content items includes a summary of a document or article published on a particular date;
assigning a reliability factor to each of said content items;
storing said information items;
establishing a subscription for said computer user;
receiving a request from said computer user for information items concerning said corporation;
creating an electronic page containing in part a share price chart having a number of data points corresponding to the share price for a date or date range and a trading volume chart having a number of data points corresponding to the trading volume for a date or date range; and
transmitting said electronic page to said computer.

80. The method of claim 79 further comprising:
receiving a selection of a data point; and
providing a display containing the content items associated with the corresponding date or date range of the data point and the reliability indicators assigned to said content items.

81. The method of claim 79 wherein said reliability indicators are different colors.

82. The method of claim 79 wherein said reliability indicators are different numbers.

83. The method of claim 79 wherein said reliability indicators are different typeface.

84. The method of claim 79 wherein said reliability indicators are different letters.

85. The method of claim 79 wherein said step of establishing a subscription for said computer user includes:
receiving personal information from said computer user, said personal information including said a name; and
receiving payment information from said computer user.

86. The method of claim 85 further comprising verifying said payment information.

87. The method of claim 85 further comprising utilizing said payment information to obtain payment.

88. The method of claim 79 wherein said information items and said reliability indicators are stored in a database.

89. The method of claim 79 wherein said information items are gathered from a plurality of sources.

90. The method of claim 89 wherein said sources include newspapers, wire services, magazines, trade journals and publicly available government documents.

91. The method of claim 89 wherein said reliability indicators are determined by the source of the content item.

92. The method of claim 89 wherein said reliability indicators are automatically assigned depending upon the source of said content item.

93. The method of claim 79 wherein said content items further include a reference to the source of said content item.

94. The method of claim 79 further including reviewing said content items for accuracy.

95. The method of claim 79 wherein said request for information items concerning said corporation includes a date range.

96. The method of claim 79 wherein said electronic page contains all of the content items and reliability indicators that may be displayed when a data point is selected.

97. The method of claim 79 wherein said electronic page does not include content items and wherein said selection of a data point causes the content items associated with the date of said data point and the reliability indicators assigned to said content items to be transmitted to said computer user for display.

98. The method of claim 79 wherein said communications network is the Internet.

99. A computer readable medium having computer-executable instructions for performing the method recited in claim 79.
